(19) United States
(12) Patent Application Publication
(10) Pub. No.: US 2002/0154784 A1
(43) Pub. Date: Oct. 24, 2002

(54) Earphone signal check device

(76) Inventor: Simon Hsieh, Walnut, CA (US)

Correspondence Address: DOUGHERTY & TROXELL, SUITE 1404, 5205 LEESBURG PIKE, FALLS CHURCH, VA, 22041, US

(21) Appl. No.: 09/836,241

(22) Filed: Apr. 18, 2001

(51) Int. Cl. H04R 29/00

(52) U.S. Cl. 381/58; 381/60

(57) ABSTRACT

An earphone signal check device includes a pin inserted in an earphone hole of any electronic appliances, an electronic circuit, a signal indicating lamp lit up by the electronic circuit when it receives a signal coming through the earphone hole and the pin, and converting the signal into a type of signal to be perceived by a user, such as flickering of an indicating lamp(s) or vibration. Thus the earphone signal check device can be used as a signal indicating device, and a signal or use condition check device.

### BACKGROUND OF THE INVENTION

This invention relates to an earphone signal check device, particularly to one having high precision, multi-functions, and wide adaptability.

Most electronic appliances such as video, acoustic and communicating ones generally have an earphone hole for a user to plug in an earphone to listen to so as not to disturb other persons around. In addition, communication appliances have been made to have an earphone hole used as a channel of signal output or control and adjustment in order to connect to listen to a wireless telephone or a volume control.

However, it cannot convert earphone signals into other forms of indicating signals received, so a person cannot feel or recognize signals received through an earphone hole for use of check or visual recreation, listening or feeling, but it only transmits sound signals to be heard.

A conventional indication device for signals received is used in common communicating appliances are for a user to know that a signal has come and immediately take a proper measure. For example, if a user is at a station, plays tennis at a tennis court, or is driving a car, and the user's mobile phone put in a brief case or handbag cannot indicate that a signal is coming to the phone such as by means of a lamp lit, a sound or vibration, evidently an auxiliary signal indicating device is needed to inform the user of a signal coming. It may be a flickering lamp by which a signal is converted, connected by an extension wire from a mobile phone placed in a brief case or handbag, or a flicking lamp connected with a mobile phone placed in front of a driver so that the driver can see the lamp to know a call is coming when the lamp flickers, and takes proper measure to listen to the call.

Next, a conventional indicating device for oncoming signals shown in FIG. 1 includes a receiving member 11 made of metal (a spring shown in the Figure) for receiving signals, a device body 10 containing an electric circuit connected to the receiving member 11 and an LED lamp for indicating. When the receiving member 11 receives a signal like an electromagnetic wave, the electric circuit in the device body 10 starts the LED lamp to flicker, which means a call is coming, and then the user may get the call at once.

The conventional indication device has the disadvantages shown below.

1. Lack of precision: Daily life appliances such as infrared cameras, house telephones, door-telephones, etc, all produce electromagnetic wave, which is very sensitive so that the receiving member 11 may often be interfered by erroneous signals to transmit signals lacking in accurateness.

2. Lack of practicability: Imagine that if a signal indicating device in a hand of a user flickers to notice the user, but the user may often be embarrassed to find that the call is not for the user but for another person owing to misjudging of the signal indicating device.

### SUMMARY OF THE INVENTION

The objective of the invention is to offer an earphone signal check device having high precision, multi-functions and wide adaptability.

The feature of the invention is that the earphone signal check device may be directly insert in the earphone hole of an electronic appliance, altering the signal transmitted through the earphone hole into a type of signal such as a flickering light, a vibration perceivable by a person, functioning as the signal indicating device or a checking device for signals or using condition of an electronic appliance.

### BRIEF DESCRIPTION OF DRAWINGS

This invention will be better understood by referring to the accompanying drawings, wherein:

FIG. 1 is a perspective view of a conventional known signal-indicating device:

FIG. 2 is an earphone signal check device in the present invention:

FIG. 3 is a first embodiment of an earphone signal check device in the present invention:

FIG. 4 is a perspective view of a second embodiment of an earphone signal check device in the present invention:

FIG. 5 is a perspective view of a third embodiment of an earphone signal check device in the present invention:

FIG. 6 is a perspective view of a fourth embodiment of an earphone signal check device in the present invention:

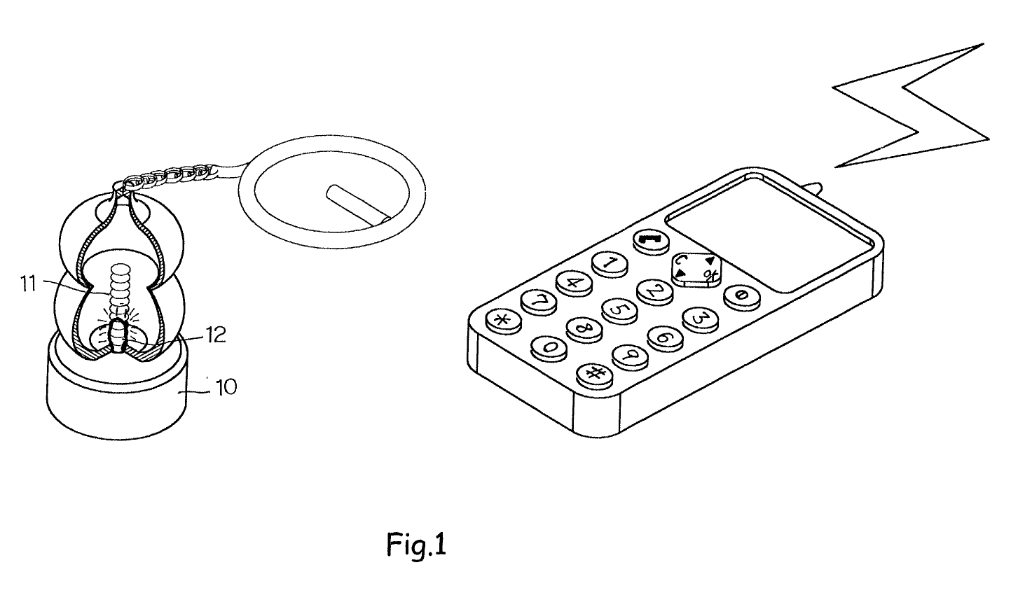

### DETAILED DESCRIPTION OF THE PREFERRED EMBODIMENTS

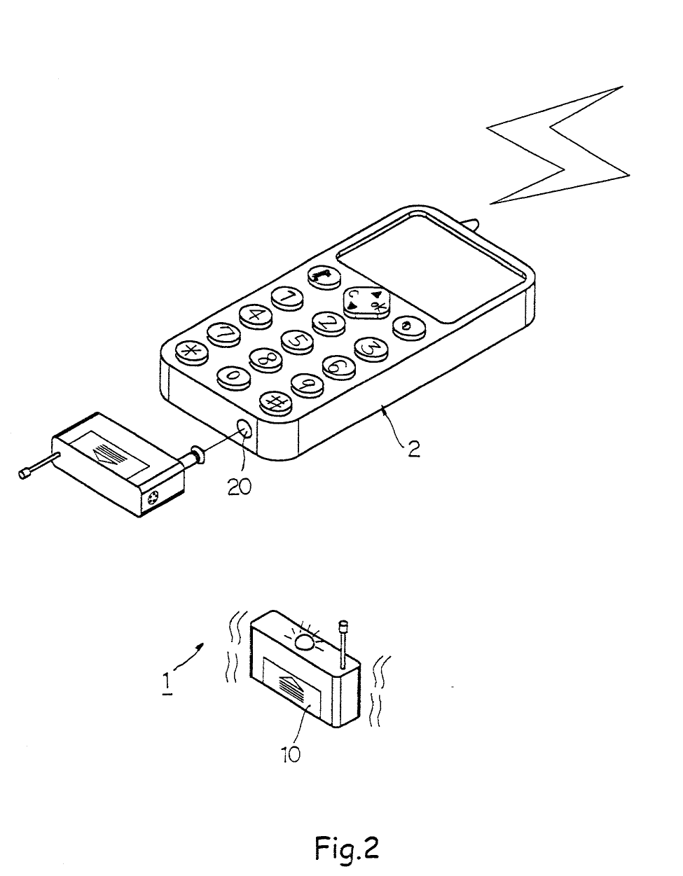

A preferred embodiment of an earphone signal check device in the invention, as shown in FIG. 2, has an improved feature which the earphone signal check device 1 is directly inserted in the earphone hole 20 of an electronic appliance such as communicating appliances, visual and acoustic appliances. Then output signals or current transmitted through the earphone hole 20 by means of wire or wireless is converted into a type of signal such as lamp flickering or vibration, functioning as a signal indicating device, a signal checking device or a use condition check device of an electronic appliance.

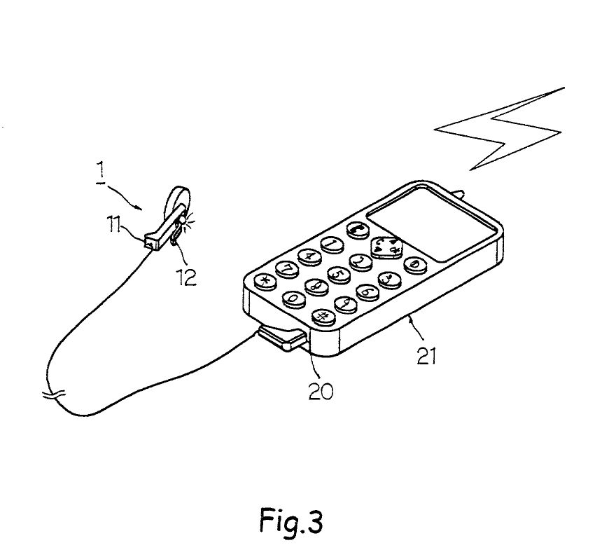

When a common electronic appliance 2 transmits sound, the earphone hole 20 surely transmits signals or current, and the earphone signal check device 1 in the invention alters the output signals through the earphone hole 20 into LED lamp flickering or vibration by means of a vibrating device, which a user may perceive. Of course, the signal of the earphone signal check device 1 may be transmitted by means of wireless or wire as shown in FIG. 3.

Provided that an output signal or current transmitted through the earphone hole 20 is strong enough, the earphone signal check device 1 can directly convert it into a result output. If an output signal or current transmitted through the earphone hole 20 is not strong enough, then a driving element (such as an amplifier) may be added in the earphone signal check device 1, or a battery room is provided additionally to contain a battery for strengthening the signal or current, making the earphone signal check device the best for use.

The signal received by the earphone signal check device 1 in the invention directly comes from an electronic appliance 2 itself, in other words, it is direct connection of the electronic appliance 2 to the earphone signal check device 1, completely different from conventional indication devices on market, which are apt to be disturbed or interfered by other signals coming from unrelated electronic appliances to cause misjudged signals to function erroneously. Thus, the earphone signal check device may not be disturbed or affected by any signals set forth by any other communication appliances. Therefore, the signals used by the earphone signal check device in the invention are absolutely precise and stable, increasing greatly its practicability, far better than conventional signal indicating devices.

Next, FIG. 3 shows a first preferred embodiment of an earphone signal check device, which may be applied to communicating appliances 21 such as mobile phones, wireless door phones, house wireless telephones, etc. As long as a communicating appliance has an earphone hole 20, the earphone signal check device 1 may be used, aside from converting earphone signals into signal indicating, also function as checking conversation of users. For example, when signals from a communicating appliance 21 comes, the earphone signal check device at once cut off the signal but only let the lamp flickering, only functioning as a signal indicating device of the communicating appliance 21. Or after a signal from a communicating appliance 21 is connected, the earphone signal check device 1 may continue to transmit the signal and let the lamp flicker, functioning as a signal indicating device and a signal check device of the communicating appliance 21. And a changeover switch may be fixed on an outer side of the earphone signal check device, handled to change functions of signal indicating or of checking using condition. As shown in the Figure, the first embodiment not only has function of listening to the earphone, but multi-functions of providing a microphone 11, a control switch 12, etc. in the device 1.

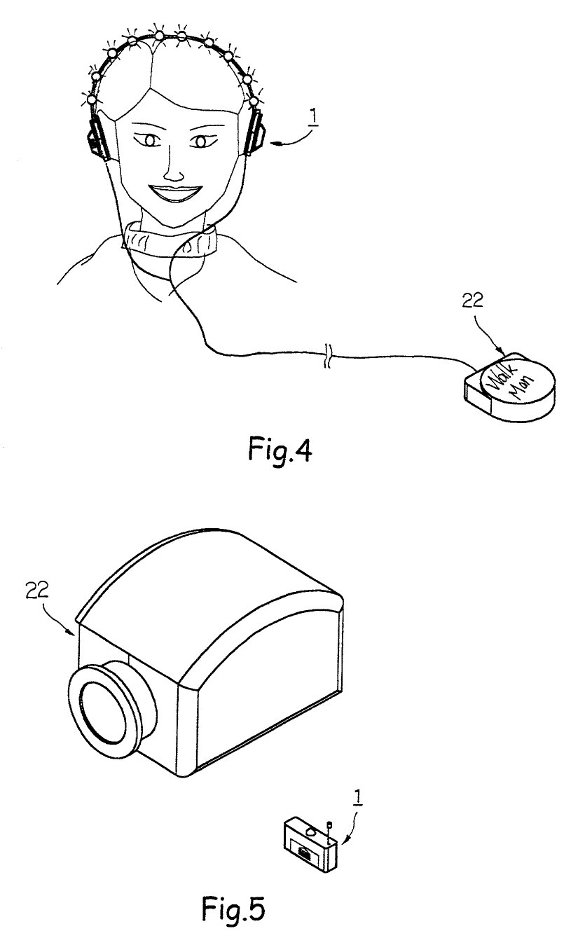

Next, FIGS. 4 and 5 shows a second and a third embodiment of an earphone signal check device, applicable to visual and acoustic appliances 22, such as radios, amplifiers, TV, DVD, personal radio cassette players, VCR, etc. provided with an earphone hole. Then earphone signals of a visual or acoustic appliance 22 may be altered into a use condition check device. FIG. 4 shows it applied to a personal radio cassette player, and the earphone hole 20 continues to transmit signals to the earphone signal check device 1 during the visual or the acoustic appliance operating, so the earphone signal check device 1 may continue to produce signals (LED flickering), noticing the user that the appliance 22 is still operating. FIG. 5 shows it applied to a VCR, functioning as a kind of checking device. When the VCR is recording, it sends signals to the earphone hole 20, and a user may use the earphone signal check device 1 in due time, checking if the VCR is normally operating or not by means of wire or wireless. Anyway, the second and the third embodiment may be combined with common earphones, permitting a user checking sounds at the same time.

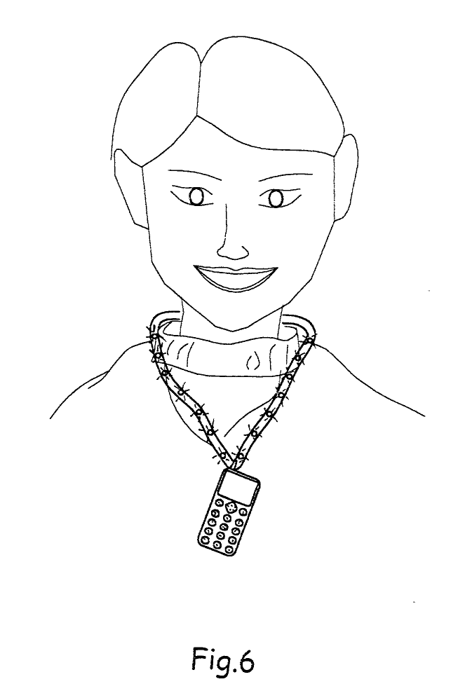

FIGS. 4 and 6 shows a fourth embodiment of an earphone signal check device 1 having plural LED lamps for indicating and decorating as well.

The earphone signal check device in the invention has the following advantages, as can be understood from the aforesaid description.

1. High precision: As signals it receives come directly from an electronic appliance itself, not from other means, that is to say, only the electronic appliance connected with it can drive it, which is not disturbed by other signals nor affects other electrical appliances. Even if two or more communicating appliances are placed side by side, only one of them connected with the earphone signal check device can transmit signal to it exclusively, having absolute attribution and precision. Especially, mobile phones are very popular and almost everyone has one, so a user who has this invention connected to his/her phone never fail to decide if a call comes to his/hers or not under the circumstance where several friends are meeting together, without possibility of happening an embarrassment of not knowing whose phone gets a call.

2. Wide adaptability: It can apply to any electronic appliances so long as the appliances have an earphone hole.

3. A single device having multi-functions: It can be used as a signal indicating device to show a call coming, a signal or use condition check device, or combined with common earphones or some device without a telephone receiver, surely increasing additional value and inciting buying desire of consumers.

4. Good practicability: It can use one or more than one LED for indicating, having effect of indicating and decorating as well.

While the preferred embodiments of the invention have been described above, it will be recognized and understood that various modifications may be made therein and the appended claims are intended to cover all such modifications that may fall within the spirit and scope of the invention.

I claim:

1. An earphone signal check device comprising a pin possible to insert in an earphone hole of any electronic appliance for receiving signals or current of any of said electronic appliances through said earphone hole, then converting said signals into a type of signals possible to be perceived by a person's body to function as indicating signals coming from any said electronic appliance, and as signal or use condition checking.

2. The earphone signal check device as claimed in claim 1, wherein said earphone signal check device receives signals transmitted through wires.

3. The earphone signal check device as claimed in claim 1, wherein said earphone signal check device receives signals transmitted by means of wireless.

4. The earphone signal check device as claimed in claim 1 wherein said earphone signal check device has a lamp source provided on its outer side.

5. The earphone signal check device as claimed in claim 4, wherein said lamp source is LED as the best.

6. The earphone signal check device as claimed in claim 1, wherein a vibration device is provided in said earphone signal check device.

7. The earphone signal check device as claimed in claim 1, wherein said earphone signal check device is formed as an earphone.

8. The earphone signal check device as claimed in claim 1, wherein said earphone signal check device is formed to have no telephone receiver.

9. The earphone signal check device as claimed in claim 1, wherein a drive element is additionally provided in said earphone signal check device, for increasing the strength of signals.

10. The earphone signal check device as claimed in claim 1, wherein said earphone signal check device is provided with a battery room.

11. The earphone signal check device as claimed in claim 1, wherein a changeover switch is provided on an outer side of said earphone signal check device.

12. The earphone signal check device as claimed in claim 4, wherein said lamp source is provided with plural LED.

13. The earphone signal check device as claimed in claim 1, wherein a microphone is installed in said earphone signal check device.

14. The earphone signal check device as claimed in claim 1, wherein a control switch is provided in said earphone signal check device.
